(19) United States
(12) Patent Application Publication
(10) Pub. No.: US 2021/0009168 A1
(43) Pub. Date: Jan. 14, 2021

(54) METHOD FOR TRANSPORTING GOODS IN CONTAINERS AND THE WAGON FOR TRANSPORTING CONTAINERS

(71) Applicant: LAUDE SMART INTERMODAL Spolka Akcyjna, Torun (PL)

(72) Inventor: Marcin WITCZAK, Torun (PL)

(21) Appl. No.: 16/860,812

(22) Filed: Apr. 28, 2020

(30) Foreign Application Priority Data
Jul. 12, 2019 (PL) P.430571

(51) Int. Cl. B61D 3/16; B65G 65/00; B61D 3/02

(52) U.S. Cl. CPC B61D 3/16; B65G 65/00; B65G 2201/0235; B65G 2814/0347; B65G 2201/0232; B61D 3/02

(57) ABSTRACT

A method for transporting goods in containers, wherein the wagon carries two layers of containers, characterized in that the bottom layer comprises containers without side walls. The goods carried in the bottom containers can be loaded and unloaded independently from the goods carried in the top containers. The bottom containers are used for transporting coils. The coils are loaded and unloaded by inserting a coil lifter arm through inner diameter of the coil. A wagon for transporting containers comprising bogies (1) and a platform (2) with side walls (3) arranged between said bogies. The height of the side wall (3) extending over the platform (2) in its lowest point does not exceed 60 cm. The wagon has a side wall (3) extending 55-60 cm above the platform (2). The side wall (3) comprises trapezoid reduced-height sections (4), wherein the side wall (3) extends 40-45 cm above the platform (2) in said reduced-height sections. The side wall (3) comprises a top reinforcing member (5). The side wall (3) and the top reinforcing member (5) are linked with connecting members (6). The height of the side wall (3) is 20-40 cm.

### FIELD OF THE INVENTION

The present invention relates to a method for transporting goods in containers and the wagon for transporting containers. The method relates to a double-stack transport of goods on wagons that carry two layers of containers. The wagon is intended for use in double-stack rail transport. The top containers are secured to the bottom containers.

### BACKGROUND

A method for transporting goods in containers where the wagon platform carries two layers of containers is known from the art. Each layer comprises of one or two containers. The double-stacking pattern is usually a single 40-feet container or two 20-feet containers. The top container(s) are secured to the bottom container(s). The goods from the bottom container can be unloaded by removing the top container(s), and removing the bottom container. With the ‘open top’ containers, the goods can be unloaded from the top by removing the top container(s) and opening the bottom container.

US2018001911 discloses a wagon with bogies and a platform with side walls arranged between said bogies. The platform is positioned below the upper edge of the bogie. The side walls provide structural rigidity and are half the height of the container.

### SUMMARY

The present invention relates to a method for transporting goods in containers, wherein the wagons carry two layers of containers, characterized in that the bottom containers are the containers without side walls. The goods in the bottom containers can be loaded and unloaded independently from the goods in the top containers. Preferably, the bottom containers are used for transporting coils. Preferably, the coils are loaded and unloaded by inserting a coil lifter arm through inner diameter of the coil.

The present invention relates to a wagon for transporting containers comprising bogies and a platform with side walls arranged between said bogies, characterized in that the height of the side wall extending above the platform in its lowest point does not exceed 60 cm. Preferably, the side wall of the wagon extends 55-60 cm above the platform. Preferably, the side wall comprises trapezoid reduced-height sections, wherein the side wall extends 40-45 cm above the platform in said reduced-height sections. Preferably, the side wall comprises a top reinforcing member. Preferably, the side wall and the top reinforcing member are linked with connecting members. The height of the side wall is 20-40 cm.

The method for transporting goods in containers allows to optimize transport in locations where double-stack rail transport is allowed. The capability to load and unload the bottom container without removing the top container significantly facilitates transport planning processes. Using the bottom container for transporting coils will significantly improve transport. A container with coils, e.g. steel sheet is a heavy load compared to containers with other goods and should be transported as a bottom container. The solution according to the invention will further increase the transport capabilities. A wagon for transporting containers with reduced-height side wall allows access to the goods in the bottom container. In particular, the invention allows to access the inner diameter of the coil and unload the coil from the container.

### BRIEF DESCRIPTION OF THE DRAWINGS

The embodiments of the invention are presented herein with reference to the following drawings:

FIG. 1 shows the wagon with a uniform height wall carrying a container for transporting coils and any other container;

FIG. 2 shows the cross-section of the wagon;

FIG. 3 shows the wagon with reduced-height sections of the side wall;

FIG. 4 shows the wagon with top reinforcing members; and

FIG. 5 shows the wagon with top reinforcing members and connecting members.

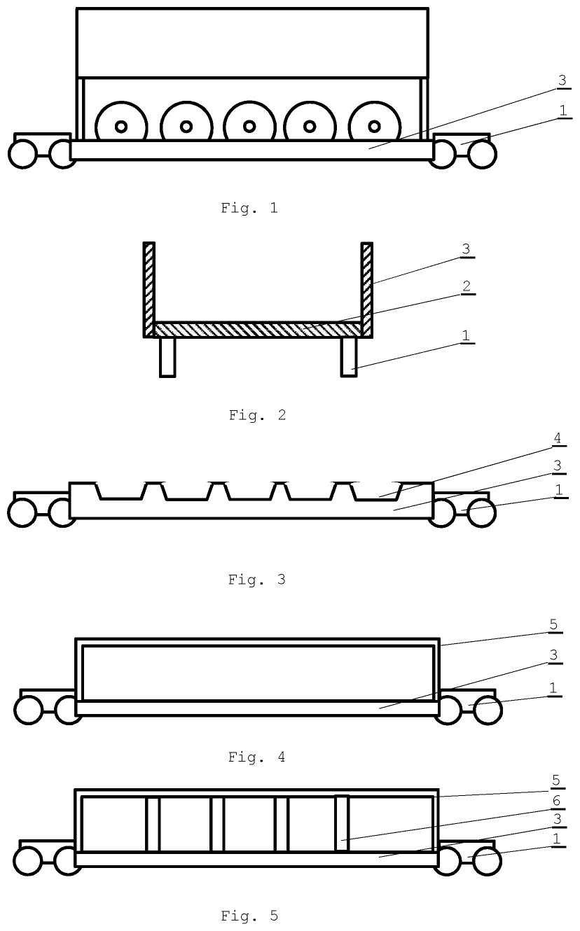

### DETAILED DESCRIPTION

Embodiment 1. A container without a side wall is positioned on the bottom layer and a standard container is positioned on the top layer of the wagon. At any stop along the route, all or part of the goods on the bottom container can be unloaded. The bottom container comprises cradles for transporting sheet metal coils. The sheet metal coils are loaded by inserting a coil lifter arm through inner diameter of the coil. A wagon for transporting containers comprises bogies 1 and a platform 2 with side walls 3 arranged between said bogies. The side wall 3 extends 58 cm above the platform 2.

Embodiment 2. A container without a side wall is positioned on the bottom layer and a standard container is positioned on the top layer of the wagon. At any stop along the route, all or part of the goods on the bottom container can be unloaded. The bottom container comprises cradles for transporting sheet metal coils. The sheet metal coils are loaded by inserting a coil lifter arm through inner diameter of the coil. A wagon for transporting containers comprises bogies 1 and a platform 2 with side walls 3 arranged between said bogies. A side wall 3 with trapezoid reduced-height sections 4. In the reduced-height sections, the side wall 3 extends 42 cm above the platform 2.

Embodiment 3. A container without a side wall is positioned on the bottom layer and a standard container is positioned on the top layer of the wagon. At any stop along the route, all or part of the goods on the bottom container can be unloaded. The bottom container comprises cradles for transporting sheet metal coils. The sheet metal coils are loaded by inserting a coil lifter arm through inner diameter of the coil. The side wall 3 comprises a top reinforcing member 5. The height of the side wall 3 is 35 cm.

Embodiment 4. A container without a side wall is positioned on the bottom layer and a standard container is positioned on the top layer of the wagon. At any stop along the route, all or part of the goods on the bottom container can be unloaded. The bottom container comprises cradles for transporting sheet metal coils. The sheet metal coils are loaded by inserting a coil lifter arm through inner diameter of the coil. The side wall 3 comprises a top reinforcing member 5. Preferably, the side wall 3 and the top reinforcing member 5 are linked with connecting members 6. The height of the side wall 3 is 20 cm.

1. A method for transporting goods in containers, wherein the wagon carries two layers of containers, characterized in that the bottom layer comprises containers without side walls.

2. The method according to claim 1, characterized in that the goods carried on the bottom layer are loaded and unloaded independently from the goods carried on the top layer.

3. The method according to claim 1, characterized in that the bottom containers are used for transporting coils.

4. The method according to claim 3, characterized in that the coils are loaded and unloaded by inserting a coil lifter arm through inner diameter of the coil.

5. A wagon for transporting containers comprising bogies and a platform with side walls arranged between said bogies, characterized in that the height of the side wall extending over the platform in its lowest point does not exceed 60 cm.

6. The wagon according to claim 5, characterized in that it has a side wall extending 55-60 cm above the platform.

7. The wagon according to claim 5, characterized in that the side wall comprises trapezoid reduced-height sections, wherein the side wall extends 40-45 cm above the platform in said reduced-height sections.

8. The wagon according to claim 5, characterized in that the side wall comprises a top reinforcing member.

9. The wagon according to claim 8, characterized in that the side wall and the top reinforcing member are linked with connecting members.

10. The wagon according to claim 8, characterized in that the height of the side wall is 20-40 cm.
